(19) United States
(12) Patent Application Publication
(10) Pub. No.: US 2006/0116792 A1
(43) Pub. Date: Jun. 1, 2006

(54) Irrigation controller

(76) Inventor: John W. Addink, Riverside, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 11/001,982

(22) Filed: Dec. 1, 2004

(51) Int. Cl. G05D 7/00

(52) U.S. Cl. 700/284

(57) ABSTRACT

An irrigation controller modifies sophisticated irrigation protocols using an extremely simple user control. In one aspect of a particularly preferred class of embodiments, the user control includes a simple “more/less” (increase/decrease) adjustment. In another aspect of preferred embodiments, the controller automatically determines appropriate irrigation amounts, start times, durations, and frequencies. Such automatic determination may advantageously be based in part on the more/less adjustment.

### FIELD OF THE INVENTION

The field of the invention is irrigation controllers.

### BACKGROUND OF THE INVENTION

Considerable resources have been invested over the years to improve irrigation controllers, especially with respect to increasing sophistication of the watering schedules. Modern controllers, for example, may manipulate half a dozen or more valves, may have multiple on/off periods during the day, may have different watering schedules from day to day during the week.

One undesirable side effect of the trend towards increasingly sophisticated controllers is that the inputs needed to drive such controllers are also becoming more complex. Typical modem controllers require a user to separately specify start times and durations for irrigation intervals for each zone and possibly for each day of the week. Modem controllers may also take into account inputs from external sensors, such as temperature, wind, precipitation and soil moisture sensors. Still further, systems are also known which receive input from a local or distal signal source, such as a radio transmitter. Exemplary disclosures are U.S. Pat. No. 4,962,522, issued October 1990, and U.S. Pat. No. 5,208,855, issued May 1993, both to Marian, and each of which is incorporated by reference herein in its totality. Such systems offer considerable advantages, including the ability to integrate historical rainfall and other data with current reference evapotranspiration (ETo) rates.

The large quantity of external data makes irrigation controllers relatively complicated to use and even systems touting automatic adjustment of irrigation flow still require relatively complicated input. Systems discussed in U.S. Pat. No. 5,208,855, for example, merely update an interval used for preset irrigation control timings, rather than determine an entirely new irrigation schedule. Similarly, systems discussed in U.S. Pat. No. 5,444,611 issued to Woytowitz et al. (August, 1995) are said to automatically calculate and execute a new schedule, but the new schedule is still based upon programming of a start time. Systems disclosed in U.S. Pat. No. 4,646,224 issued to Ransburg et al. (February, 1987) automatically determine the number of cycles and length of time of each cycle that water is to be applied, but still requires the operator to provide data concerning desired sprinkling days, soil type, the type of sprinkler for each zone, and so forth.

The trend towards increasingly sophisticated controllers is accompanied by a trend towards having ever fewer input controls accessible to the user. Decreasing the number of input controls may reduce the cost and size of a controller unit but it also adds to the complexity of using the unit. The whole process of adjusting a modem irrigation controller can be compared to programming a VCR. It may be advantageous to have available a large number of different functions but controlling all of those functions using only half a dozen or so buttons is extremely difficult for many individuals. This problem has been resolved to some extent in VCR controllers by utilizing the TV screen as an interactive display but that approach is not readily adaptable to irrigation controllers, where a relatively small, inexpensive display screen is employed to reduce costs.

Even if the process of modifying controller parameters were not complex, determining appropriate values for the required input parameters may be exceedingly complex. As an example, modifying a watering duration value to provide more water to a particular irrigation zone might involve all of the following steps: (1) determining the total of all the watering durations currently programmed for the zone over the course of a week; (2) estimating an appropriate change in the amount of water to be applied to the zone; (3) translating that amount into a percentage increase over the presently programmed total; (4) translating such percentages into changes in durations and deciding how such changes in durations should be distributed over the existing schedule; and (5) entering the scheduling changes. Step 4 is particularly difficult for many individuals because there are often no established guidelines for deciding among various options. Thus, a user may have insufficient knowledge to decide between reducing the watering for each day by 10 minutes, or eliminating watering entirely two days per week.

In short, the steadily increasing sophistication of irrigation controller outputs, coupled with the steadily increasing difficulty of operating such controllers, is a significant problem for users. Thus, there is a continuing need to provide sophisticated irrigation control, while providing simple operator input.

### SUMMARY OF THE INVENTION

Methods and apparatus are provided herein for controlling irrigation to irrigated zones, comprising: providing water to be applied to more than one irrigated zone at an irrigated site; providing an irrigation controller that controls the application of the water to the irrigated zones; and operating a more/less adjustment mechanism, on the irrigation controller, that modifies the amount of water applied to at least one irrigated zone in an inverse relationship to the amount of water applied to the remaining irrigated zones at the irrigated site.

In a preferred embodiment of the present invention, the irrigation controller will execute an irrigation schedule to the irrigated site and then the irrigated site will be examined to determine the effect of irrigating according to the irrigation schedule.

It is contemplated that if a change is required to the amount of water that is applied to one or more irrigated zones that the user can operate a more/less adjustment mechanism to modify the irrigation schedule to arrive at a new irrigation schedule. The new irrigation schedule is then executed to the irrigated site by the irrigation controller. Preferably, the operating of the more/less adjustment mechanism comprises operating a first button corresponding to increasing the amount of water provided to at least one irrigated zone and a second button corresponding to decreasing the amount of water provided to at least one irrigated zone. Alternatively, the operating of the more/less adjustment mechanism may comprise operating a slide control, a rotating control knob or any other device that will provide for the increasing or decreasing of the water applied to at least one irrigated zone.

In a preferred embodiment of the present invention the irrigation controller derives irrigation schedules, which may be at least partly, from reference evapotranspiration (ETo) data.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a schematic of an irrigation controller according to the present invention.

FIG. 2 is a schematic of a method embodying an irrigation controller, according to the present invention.

### DETAILED DESCRIPTION

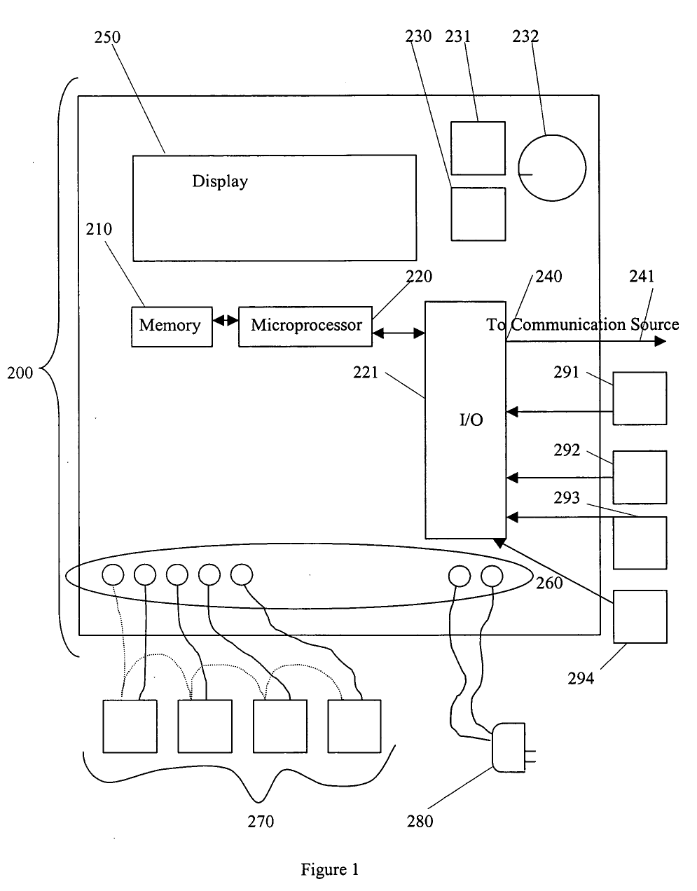

Referring to FIG. 1, an irrigation controller 200 according to the present invention generally includes a microprocessor 220, an on-board memory 210, some manual input devices 230 through 232 (buttons and/or knobs), an input/output (I/O) circuitry 221 connected in a conventional manner, a display screen 250, a communications port 240, a serial, parallel or other communications connection 241 coupling the irrigation controller to one or more communication sources, electrical connectors 260 which are connected to a plurality of irrigation stations 270 and a power supply 280. Additionally, the irrigation controller may be connected to a rain detection device 291, a flow sensor 292, a pressure sensor 293 and/or a temperature sensor 294. Each of these components by itself is well known in the electronic industry, with the exception of the programming of the microprocessor in accordance with the functionality set forth herein. There are hundreds of suitable chips that can be used for this purpose. At present, experimental versions have been made using a generic Intel 80C54 chip, and it is contemplated that such a chip would be satisfactory for production models.

In a preferred embodiment, the controller has one or more common communication internal bus(es). The bus can use a common or custom protocol to communicate between devices. There are several suitable communication protocols, which can be used for this purpose. At present, experimental versions have been made using an I²C serial data communication, and it is contemplated that this communication method would be satisfactory for production models. This bus is used for internal data transfer to and from the EEPROM memory, and is used for communication with personal computers, peripheral devices, and measurement equipment including but not limited to a rain detection device, a flow sensor, a water pressure sensor and a temperature sensor.

It is contemplated that the microprocessor will be disposed in an irrigation controller. Alternatively, the microprocessor may be disposed in a personal computer or other device that provides control of an irrigation system.

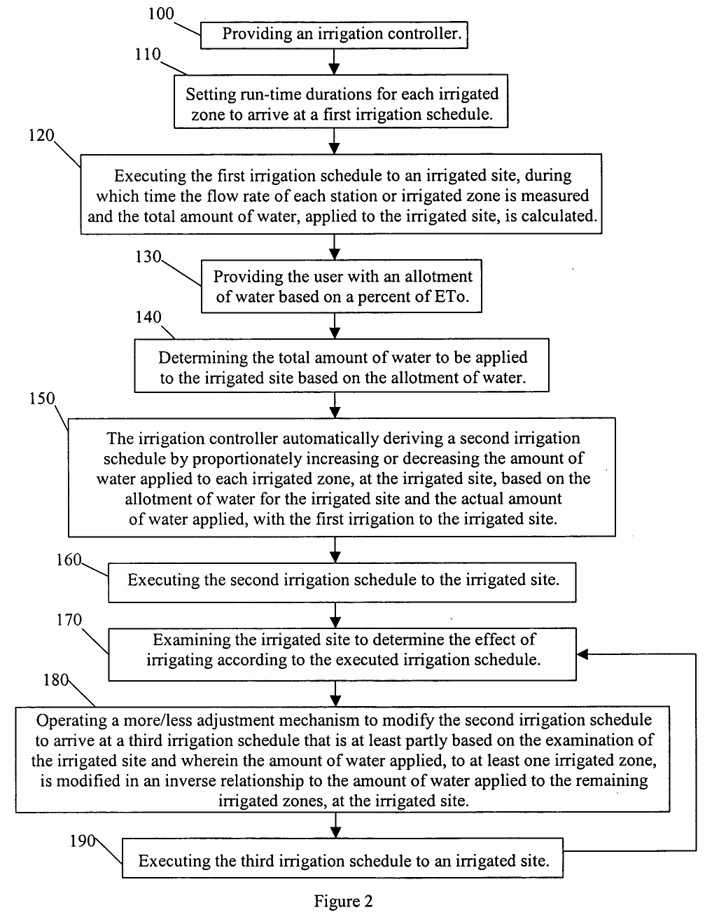

FIG. 2 is a method embodying an irrigation controller according to the present invention. An irrigation controller is provided (step 100) in which a user initially sets run-time durations for each irrigated zone to arrive at a first irrigation schedule (step 110). In step 120 the irrigation controller executes the first irrigation schedule to an irrigated site, during which time the flow rate of each station or irrigated zone is measured and the total amount of water, applied to the irrigated site, is calculated. Preferably, the measurement of the water flow to the irrigated site is accomplished with a single flow meter located at the irrigated site that is used for measuring the total water used at the residential, commercial, etc. site (See pending U.S. patent application Ser. No. 10/297,146). Alternatively, the measurement of the water flow to the irrigated site is accomplished with a separate, dedicated flow meter.

In a preferred embodiment of the present invention, a water district, government agency or other entity may provide the user with an allotment of water. Alternatively, it can be appreciated that the user may choose to reduce the water applied to his/her landscape because of conservation pricing and the savings they could obtain by applying an amount of water that allows them to be in the lower tier of a conservation pricing scheme. Preferably, the allotment, provided the user, will be based on a percent of ETo (step 130). However, it can be appreciated that the allotment could be a volume of water, set number of minutes of watering or any other appropriate measurement that could indicate a volume of water that could be applied, during a specific time period, to a specific irrigated site.

The total amount of water to be applied to the irrigated site is determined in step 140. If the allotment of water is based on a percent of ETo then the allotment, in gallons of water, is determined by the following formula: percent ETo times ETo times the total irrigated site area, measured in square feet, times 7.5 gallons per cubic foot, which is then divided by 12 inches per foot. Assume that the percent ETo is set at 90%, the ETo value for a given day is 0.25 inches and the total square feet of the irrigated area is 5000 square feet. Then, using the formula above, we arrive at an allotment of approximately 700 gallons of water that can be applied the following day to the irrigated site (Generally, a specific days irrigation application will be based on the previous days ETo value). It should be appreciated that the allotment of water can be determined on a basis other than daily, such as weekly, monthly, and so forth.

In a preferred embodiment of the present invention, the irrigation controller will automatically derive a second irrigation schedule by proportionately increasing or decreasing the amount of water applied to each irrigated zone at the irrigated site, based on the allotment of water for the irrigated site and the actual amount of water applied, with the first irrigation to the irrigated site (step 150). Assume that 777 gallons was the actual amount of water that was applied with the first irrigation schedule to the irrigated site. To apply the allocated amount of water or 700 gallons of water to the irrigated site, the actual amount of water, applied to the irrigated site, will have to be reduced by 77 gallons or approximately by 10%. As mentioned earlier, preferably this will be accomplished by proportionately reducing the run-time durations for each of the irrigated zones by 10%. However, it can be appreciated that the run-time durations may be reduced for some irrigated zones differently than for other irrigated zones, as long as the total reduction in water, actually applied to the irrigated site, is reduced by 77 gallons so that the 700 gallon allocation amount is not exceeded.

In step 160, the irrigation controller will execute the second irrigation schedule to the irrigated site. In step 170 the irrigated site is examined to determine the effect of irrigating according to the executed irrigation schedule. The examination is preferably visual, but may be accomplished by any suitable means, such as using a soil moisture sensor, which may be inserted into one or more sites in the soil of an irrigated zone. The examination is preferably carried out after step 160 has been ongoing for a substantial period of time, such as several days of watering using the second irrigation schedule. This provides a good baseline from which reasonable decisions regarding changes in the irrigation schedule can be made. Alternatively, however, inspection can take place after or even during a single watering.

After one or more inspections (step 170), it is contemplated that the user may desire to modify the water applied to one or more irrigated zones. Preferably the user will operate the more/less adjustment mechanism to modify the second irrigation schedule to arrive at a third irrigation schedule that is at least partly based on the examination of the irrigated site and wherein the amount of water applied, to at least one irrigated zone, is modified in an inverse relationship to the amount of water applied to the remaining irrigated zones at the irrigated site (step 180). For example, it may be desirable to increase the watering of irrigated zones 2 and 4 relative to the then-existing irrigation schedule. To accomplish this the user might press a button to access irrigated zone 2 and then press a “more” button to increase the water applied to irrigated zone 2 and follow the same procedure for irrigated zone 4. In a preferred embodiment of the present invention, the increase in the amount of water applied to irrigated zones 2 and 4 will result in a like decrease in the water applied to at least one other irrigated zone at the irrigated site.

The actual strategy by which an irrigation controller modifies the watering schedule for one or more irrigated zones, as disclosed herein, may vary among different embodiments of the controllers. It may be, for example, that each pressing of the “more” button increases the watering of that zone by 5% and that each pressing of the “less” button decreases the watering of that zone by 5%. That change may be reflected in an across the board change in all watering durations, and/or perhaps in the addition or subtraction of an entire watering day.

In the following example, the same assumption is made, as in the above example, where the allotment of water was 700 gallons per day to be applied to the irrigated site. Further assume that on a specific day 180, 150, 210 and 160 gallons of water are applied to zones 1, 2, 3 and 4, respectively, which is equal to the 700 gallon water allotment for that day. Further, assume that the more adjustment modification to irrigated zones 2 and 4, mentioned above, would result in an increase in the gallons applied to irrigated zones 2 and 4 of 40 and 37 gallons, respectively. The total gallons that would be applied to irrigated zones 1, 2, 3 and 4 would now be 180, 190, 210 and 197 gallons, respectively. This would result in a total gallons of 777 gallons being applied to the irrigated site, which would be 77 gallons over the 700 gallon allotment for the site. As mentioned earlier, preferably the irrigation controller will automatically maintain the allotment of water by proportionately decreasing the amount of water applied to each irrigated zone at the irrigated site. Therefore, there would be an approximate 10% decrease in the water applied to each irrigated zone. A 10% decrease in the water applied to each irrigated zone will result in approximately 162, 171, 189 and 178 gallons of water being applied to irrigated zones 1, 2, 3 and 4, respectively. This would result in 700 gallons being applied to the irrigated site, which is equal to the allotment of water for the irrigated site.

As mentioned earlier, it is contemplated that to achieve actual water applications that do not exceed the allotment, the run-time durations may not always be reduced proportionately for all the irrigated zones at an irrigated site. In some situations, to achieve actual water applications that do not exceed the allotment, it may be advantageous for run-time durations for some irrigated zones to be reduced differently than for other irrigated zones at the irrigated site. For example, if irrigated zones 2 and 4 involve turf areas and irrigated zones 1 and 3 involve ornamental plantings, then it might be advantageous to have the decrease in water occur entirely in irrigated zones 1 and 3 with no change in the watering of the turf areas or in irrigated zones 2 and 4. It can be appreciated, that when the operation of the more/less adjustment mechanism results in an increase in the water applied to one or more irrigated zones that the inverse relationship or decrease in the water applied to the remaining irrigated zones can be accomplished by various means. The opposite would occur, when a more/less adjustment would provide a decrease in the water applied to one or more irrigated zones and with an inverse relationship there would be an increase in the water applied to the remaining zones.

In step 190, the irrigation controller will execute the third irrigation schedule to an irrigated site. Then the irrigated site will be examined to determine the effect of irrigating according to the execution of the irrigation schedule (step 170) and if need be, additional adjustments, with the more/less adjustment mechanism, will be made to the irrigation schedule (step 180).

FIG. 2 discloses that the first irrigation schedule was derived from the user setting run-time durations. Furthermore, the second and third irrigation schedules resulted from the irrigation controller automatically modifying irrigation schedules to prevent the amount of water, applied to the irrigated site, from exceeding the allotment after initially setting the run-time durations and after the operation of the more/less adjustment mechanism, respectively. However, it can be appreciated that the more/less adjustments, contemplated herein, may only indirectly control the amount of water provided to an irrigation zone. This is because the contemplated irrigation controller may advantageously determine irrigation schedules based upon one or more algorithms involving many parameters. For example, in addition to the irrigation schedule change that will have occurred from the operation of the more/less adjustment mechanism in step 180, the irrigation controller may use ETo data, crop coefficient values, irrigation efficiency values, rainfall data, soil characteristics, topography and other data in the derivation of irrigation schedules executed by the irrigation controller. In a preferred embodiment of the present invention the irrigation controller derives irrigation schedules at least partly from ETo data. The ETo data used may advantageously comprise current ETo data (i.e., ETo data within the last week, three days, or most preferably within the last 24 hours). Preferably the ETo value is derived from a calculation involving the following four weather factors; solar radiation, temperature, wind and relative humidity. Alternatively, the ETo data may be based on a regression model using one or more of the factors used in calculating the above ETo value (as for example that described in U.S. patent application Ser. No. 10/009,867) or the ETo data may be based on historical ETo data.

Thus, specific embodiments and applications of methods of controlling irrigation have been disclosed. It should be apparent, however, to those skilled in the art that many more modifications besides those already described are possible without departing from the inventive concepts herein. For example, the more/less adjustment might affect all controlled valves at once, or might be limited to a subset of the controlled valves with additional more/less adjustments being provided for each subset. Similarly, it is possible to utilize various types of more/less controls such as buttons, sliders, rotating knobs, touch screens, and similar devices, which affects more or less water, and/or some other watering parameter such as frequency or duration. The inventive subject matter, therefore, is not to be restricted except in the spirit of the appended claims.

1. A method of controlling irrigation to irrigated zones, comprising:
providing water to be applied to more than one irrigated zone at an irrigated site;
providing an irrigation controller that controls watering amounts to plurality of irrigation zones, to provide a total watering amount below a maximum watering amount;
a user operating a more/less adjustment mechanism to increase the first watering amount; and
the controller automatically adjusting the watering amounts to all irrigation zones such that the total watering amount remains below the maximum watering amount.

2. The method of claim 1, further comprising the irrigation controller executing an irrigation schedule to the irrigated site.

3. The method of claim 2, further comprising examining the irrigated site to determine the effect of irrigating according to the irrigation schedule.

4. The method of claim 3, further comprising operating the more/less adjustment mechanism to modify the irrigation schedule to arrive at a new irrigation schedule that is at least partly based on the examination of the irrigated site.

5. The method of claim 4, further comprising the irrigation controller executing the new irrigation schedule to the irrigated site.

6. The method of claim 1, wherein the step of operating a more/less adjustment mechanism comprises operating a first button corresponding to increasing the amount of water provided to at least one irrigated zone and a second button corresponding to decreasing the amount of water provided to at least one irrigated zone.

7. The method of claim 1, wherein the step of operating a more/less adjustment mechanism comprises operating a slide control.

8. The method of claim 1, wherein the step of operating a more/less adjustment mechanism comprises operating a rotating control knob.

9. An irrigation controller that controls irrigation to first and second irrigation zones, comprising;
a user input;
a microprocessor that receives a signal from the user input, and that executes a program that implements the user input as a function of relative watering times of the first and second irrigation zones at a irrigated site.

10. The irrigation controller of claim 9, further comprising the irrigation controller deriving irrigation schedules at least partly from reference evapotranspiration (ETo) data.

11. The irrigation controller of claim 10, further comprising the irrigation controller executing the irrigation schedules to the irrigated site.

12. The irrigation controller of claim 11, further comprising examining the irrigated site to determine the effect of irrigating according to the irrigation schedules.

13. The irrigation controller of claim 12, further comprising operating the more/less adjustment mechanism to modify an irrigation schedule to arrive at a new irrigation schedule that is at least partly based on the examination of the irrigated site and the ETo data.

14. The irrigation controller of claim 13, further comprising the irrigation controller executing the new irrigation schedule to the irrigated site.

15. The irrigation controller of claim 9, wherein the operating of the more/less adjustment mechanism comprises operating a first button corresponding to increasing the amount of water provided to at least one irrigated zone and a second button corresponding to decreasing the amount of water provided to at least one irrigated zone.

16. The irrigation controller of claim 15, wherein the operating of the more/less adjustment mechanism comprises operating a slide control.

17. The irrigation controller of claim 15, wherein the operating of the more/less adjustment mechanism comprises operating a rotating control knob.

18. A method of controlling irrigation to irrigated zones, comprising:
providing an irrigation controller that controls a first watering amount to a first one of the irrigation zones and a second watering amount to a second one of the irrigation zones;
a user operating a more/less adjustment mechanism to modify the first watering amount; and
the controller automatically thereafter modifying both the first and second watering amounts in an opposite direction from that induced by the user's operating the more/less adjustment mechanism.
